(19) United States
(12) Patent Application Publication
(10) Pub. No.: US 2021/0374838 A1
(43) Pub. Date: Dec. 2, 2021

(54) Online photography sale method resulting in printing a URL

(71) Applicant: Sarmad Mohammad, London (CA)

(72) Inventor: Sarmad Mohammad, London (CA)

(21) Appl. No.: 16/882,799

(22) Filed: May 26, 2020

(51) Int. Cl. G06Q 30/06; G06T 1/00; G06F 16/955

(52) U.S. Cl. CPC G06Q 30/0643; G06F 16/955; G06T 1/0021

(57) ABSTRACT

This process fundamentally changes the sales cycle in the interaction between a camera and a customer with the intention of selling the picture taken by the camera to the customer as a product. Due to technological and process advancements we are now able to use a website and an associated application to print a direct link to watermarked pictures. This allows customers to access the watermarked picture directly by entering one url given to them on a piece of paper into their internet enabled device. Once they see the watermarked image they can pay for the original picture or directly associated products. This is an alternative to the current system of pre-printed cards with unique identifiers, that currently dominates the market.

### CROSS-REFERENCE TO RELATED APPLICATIONS

Not Applicable

### STATEMENT REGARDING FEDERALLY SPONSORED RESEARCH OR DEVELOPMENT (IF APPLICABLE

Not Applicable

### REFERENCE TO SEQUENCE LISTING, A TABLE, OR A COMPUTER PROGRAM LISTING COMPACT DISC APPENDIX (IF APPLICABLE

Not Applicable

### BACKGROUND OF THE INVENTION

This Utility patent application is for a new process on the way photographs are sold to end consumers. The field of endeavor includes photography, technology, and sales-cycle process.

Currently during photograph sale interactions the supplier of the photography services provides one of the below options to ensure the customer has access to purchase the images taken.
1. The image is printed physically and handed to the customer. This does not provide an electronic copy to the customer.
2. The customer is given a pre-printed ticket with a unique code and is asked to meet the service provider at a set location with the ticket. Meeting at a set location is inconvenient for the customer.
3. Pre-printed cards are created with unique codes, the photographer matches these codes to his/her picture when uploading online. This method requires pre-printed cards, input to enter or scan the unique code and align it to the images and a way for the customer to search for the pictures by using the code on a website.
4. The photographer takes the personal information of the customer, this requires the customer to share his or her personal information, some individuals do not want to give away this information. This method also takes time away from the photographer to get the information and input it.

Examples of the above scenarios includes images taken at amusement parks by staff to be sold to customers. Images taken at restaurants to be sold to customers. Images taken at resorts and excursions to be sold to customers. In all scenarios a real world interaction is taking place between a photographer and a customer as a part of the sales process the customer must have access one way or another to purchase the images from the seller.

This process will simplify this interaction, remove the need for a physical locations, removes the need for the customer to provide any information, removes the need for the customer to search for the image, removes the need for pre-printed cards with unique codes and will provide direct access to purchase the images taken. Other methods solve some, but not all of the above issues. This process solves all the issues above, this allows any individual that has access to a Smartphone (or computer), internet and printer to be able to use this process through my website and application to take images and sell them to customers. This opens up this field significantly by easing the entry requirements and improving the customers experience.

### BRIEF SUMMARY OF THE INVENTION

The process is as follows. Picture(s) is taken, uploaded to website, website creates unique purchase webpage, website sends unique purchase webpage URL (web address) to phone application, phone application sends URL to printer, printer prints the URL of the unique purchase webpage, paper is given to customer with the URL, customer can access link through internet connected device and view the watermarked image and purchase the image by typing in the URI provided.

This process improves the photographers experience by eliminating the need for a physical location, eliminating the need to obtain customer information, eliminates the need for pre-printed cards, eliminates the need for any verbal communication with the customer.

This process improves the customers experience by eliminating the need to go to a physical location, eliminating the need to provide any contact information, eliminates the need to search for an image using a unique code on a website, eliminates the need to download customized software, eliminates the need for any communication with the photographer and eliminates the need for the customer to write down or note anything.

This process also eliminates the need for an individual to be present to take the pictures, hand cards out, or manage the process. Picture can be taken automatically, timed or by the customer clicking a button, uploaded online and the direct purchase link printed.

### BRIEF DESCRIPTION OF THE SEVERAL VIEWS OF THE DRAWING

Not Applicable

### DETAILED DESCRIPTION OF THE INVENTION

Picture(s) is taken using a camera, this can be a smartphone camera, DSLR camera, a point and shoot camera or any other type of camera. Videos can also be taken and follow the same process. If the device taking the picture is not already connected to the internet and has the ability to access websites. Then the picture has to be uploaded to an electronic device that has access. This can be a tablet, computer, smartphone or any other technology. This upload can be done by a physical wire between the devices, through a wireless connection between the devices for example bluetooth or any other method available.

From this device, a website is accessed, this website allows an individual or company to sign up as a vendor (photographer). Setting up an account is only required once. This creates the vendor a unique username and password. Once logged in the vendor can click a button to create a new product. This redirects the vendor to a page were they can upload the picture taken by browsing their device. The vendor can also type in an amount to charge for the picture. After this the vendor submits the product by hitting a button. The website takes this information and creates a unique purchase page. This page has a watermarked image of the uploaded picture and creates a purchase button.

The website calls an application on the vendors device, that has been installed previously and sends the unique purchase page URL that was just created to the application. This application allows the vendor to send this unique URL in 3 ways, by text, by email and to a printer. If sent to the printer, the printer will print the URL. The vendor takes the paper that was printed and provides it to the customer. The application is currently an important part of the process due to the limitation of printing from a websites using Android and IPhone devices. To allow this feature I have created an android application, that can take advantage of a thermal bluetooth printer. Other applications for other devices will be created in the future or with technology advancements in the future we maybe able to print directly from the website on an Android or Iphone device

The ability to print the URL and present it to the customer is the most vital part of this process and is an innovation that is not used in any current process involving the interaction between a camera and a customer with the intention of selling the picture taken by the camera to the customer as a product.

The customer uses their internet connected device, that can access websites and types in the URL provided on the paper. This sends them directly to the unique purchase page. From here the customer can see the watermarked picture that was taken, and make a purchase decision. If the customer decides to purchase, they input their payment information. Once the payment is confirmed, they can download the image directly from the website. They can also provide their email address to receive an electronic receipt and link to download the picture by email.

The customer receiving a physical paper with a direct link that takes them directly to the webpage with the watermarked image(s) that is available for purchase is the second most vital part of this process and is only achievable because this process does not require pre-printed cards/paper. With pre-printed cards customers can only be guided to websites were they can search for the image, by inputting the unique code or other search method for example selecting the date the picture was taken, this adds an additional step to the process and inconveniences the customer.

1. A method of selling a picture(s), comprising the steps of:
A picture(s) is taken with the intention to sell;
picture(s) is uploaded online and watermarked;
A link that enables the customer to purchase the picture(s) or products directly related to the picture(s) without the watermark is printed and given to the potential customer.

2. A method of selling a picture(s), comprising the steps of:
A picture(s) is taken with the intention to sell;
picture(s) is uploaded online and watermarked;
A direct link to the watermarked picture(s), that enables the customer to purchase the picture(s) or products directly related to the picture(s) without the watermark is physically given to the potential customer.
